(19) United States
(12) Patent Application Publication
(10) Pub. No.: US 2007/0220258 A1
(43) Pub. Date: Sep. 20, 2007

(54) Method, apparatus, and computer product for computing credibility

(75) Inventors: Hironobu Kitajima, Kawasaki (JP); Ryo Ochitani, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/508,638

(22) Filed: Aug. 23, 2006

(30) Foreign Application Priority Data
Mar. 20, 2006 (JP) 2006-076996

(51) Int. Cl. H04L 9/00

(52) U.S. Cl. 713/175; 713/156; 713/173

(57) ABSTRACT

A credibility computing apparatus calculates credibility of a certificate based on use duration of the certificate. The use duration is a duration from the date of issue of the certificate to the current date.

### BACKGROUND OF THE INVENTION

1. Field of the Invention

The present invention relates to a technology for computing credibility of a certificate as a parameter for deciding whether the certificate is duly acquired by a right person.

2. Description of the Related Art

Various methods are known for verifying identity of a person based on a certificate issued by a government authority. It is decided whether to provide a certain service to the person based on the result of the verification. Fraudulent methods used in this process are roughly categorized into “counterfeiting” and “spoofing”.

Counterfeiting means an action to modify stated items and/or a photograph on a certificate physically or electronically, or an action to create a certificate similar to a genuine one. Counterfeiting can be prevented by a physical measure such as watermark or hologram, or by an electronic measure such as issuing a certification as an integrated circuit (IC) card or digital signature. A conventional technology has been disclosed in, for example, Japanese Patent Publication No. 3588042.

By contrast, spoofing means an action to use a certificate fraudulently acquired by pretending as a person in question. Because a certificate used by spoofing does not have any physical or electronic difference from a rightful certificate, there has been no effective protection as in the case of counterfeiting.

In the past, verification of identity of a person has been generally conducted in person. However, recently the opportunities to conduct the verification remotely via a network have increased due to development of so-called electronic governments. As a result, there is a possibility of increase in fraudulent transactions by spoofing.

Thus, there is a need of a technology that can prevent spoofing.

### SUMMARY OF THE INVENTION

It is an object of the present invention to at least partially solve the problems in the conventional technology.

According to an aspect of the present invention, a method of computing credibility of a certificate that indicates the possibility that the certificate is duly acquired by a person to be certified with the certificate includes acquiring attribute information that includes a date of issue of the certificate; calculating a use duration of the certificate, wherein the use duration is a duration from the date of issue to a current date; and computing credibility of the certificate based on calculated use duration.

According to another aspect of the present invention, a credibility computing apparatus that computes credibility of a certificate that indicates the possibility that the certificate is duly acquired by a person to be certified with the certificate includes an information acquiring unit that acquires attribute information that includes a date of issue of the certificate; a use-duration calculating unit that calculates a use duration, wherein the use duration is a duration from the date of issue to a current date; and a credibility computing unit that computes credibility of the certificate based on calculated use duration.

According to still another aspect of the present invention, a computer-readable recording medium stores therein a computer program that causes a computer to execute the above method.

According to still another aspect of the present invention, a computer-readable recording medium that stores therein a computer program that causes a computer to determine whether to provide a service to a person based on credibility of a certificate presented by the person, wherein the computer program causes the computer to execute computing credibility of the certificate based on a use duration of the certificate, wherein the use duration is a duration from a date of issue of the certificate to current date; and determining whether to provide any one of the service and contents of the service based on comparison of computed credibility of the certificate and a threshold.

According to still another aspect of the present invention, an apparatus for determining whether to provide a service to a person based on credibility of a certificate presented by the person includes an credibility computing unit that computes credibility of the certificate based on a use duration of the certificate, wherein the use duration is a duration from a date of issue of the certificate to a current date; and a determining unit that determines whether to provide any one of the service and contents of the service based on comparison of computed credibility of the certificate and a threshold.

According to still another aspect of the present invention, a method of determining whether to provide a service to a person based on credibility of a certificate presented by the person includes computing credibility of the certificate based on a use duration of the certificate, wherein the use duration is a duration from a date of issue of the certificate to a current date; and determining whether to provide any one of the service and contents of the service based on comparison of computed credibility of the certificate and a threshold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a chain of processes for verifying identity of a person;

FIG. 2 is a schematic for explaining issuance of a passport based on credibility according to an embodiment of the present invention;

FIG. 3 is a functional block diagram of a credibility computing apparatus according to the embodiment;

FIG. 4 is an example of the contents of credibility information;

FIG. 5 is a functional block diagram of a credibility computing apparatus according to another embodiment of the present invention;

FIG. 6 is a functional block diagram of a credibility computing apparatus according to still another embodiment of the present invention;

FIG. 7 is a flowchart of a processing procedure performed by the credibility computing apparatus shown in FIG. 3;

FIG. 8 is a flowchart of a certificate updating process performed by the credibility computing apparatus shown in FIG. 3;

FIG. 9 is a flowchart of a process for determining availability of a service by using the credibility computing apparatus shown in FIG. 3;

FIG. 10 is a flowchart of a process for determining a loan amount by using the credibility computing apparatus shown in FIG. 3; and

FIG. 11 is a functional block diagram of a computer that realizes the procedures, methods, or steps according to the above embodiments.

### DETAILED DESCRIPTION OF THE PREFERRED EMBODIMENTS

Exemplary embodiments according to the present invention will be explained below in detail with reference to accompanying drawings.

To begin with, a principle of a credibility computing method according to an embodiment of the present invention will be explained. Items that are generally used to verify identity of a person, such as an ID card, a badge, and a written document, are referred herein as a certificate.

In most cases, the purpose of spoofing is not to obtain the certificate itself, but to gain some kinds of benefits using the certificate to lie about a person's identity. For example, a fraudulent person will not spoof and obtain a driving license to drive a car, but he will generally use the driving license to open a dummy bank account or the like.

For this reason, a certificate acquired by spoofing is generally used in a short time after their acquisition. To posses the certificate for a long time is disadvantageous to the fraudulent person, because that could lead to increase in the possibility that a fraudulent transaction is revealed. Therefore, it is common for the fraudulent person to destroy the certificate promptly after his objective is achieved.

Accordingly, a use duration, which is the duration between acquisition and use of a certificate, is shorter for fraudulent certificates than the same for the duly acquired certificates. In view of this fact, in the credibility computing method according to the embodiments, the use duration is used as a criterion for evaluating credibility of the certificate.

In the credibility computing method according to the embodiments, when evaluating credibility of a certificate, accumulation of credibility resulting from a chain of processes for verifying identity of a person is taken into account.

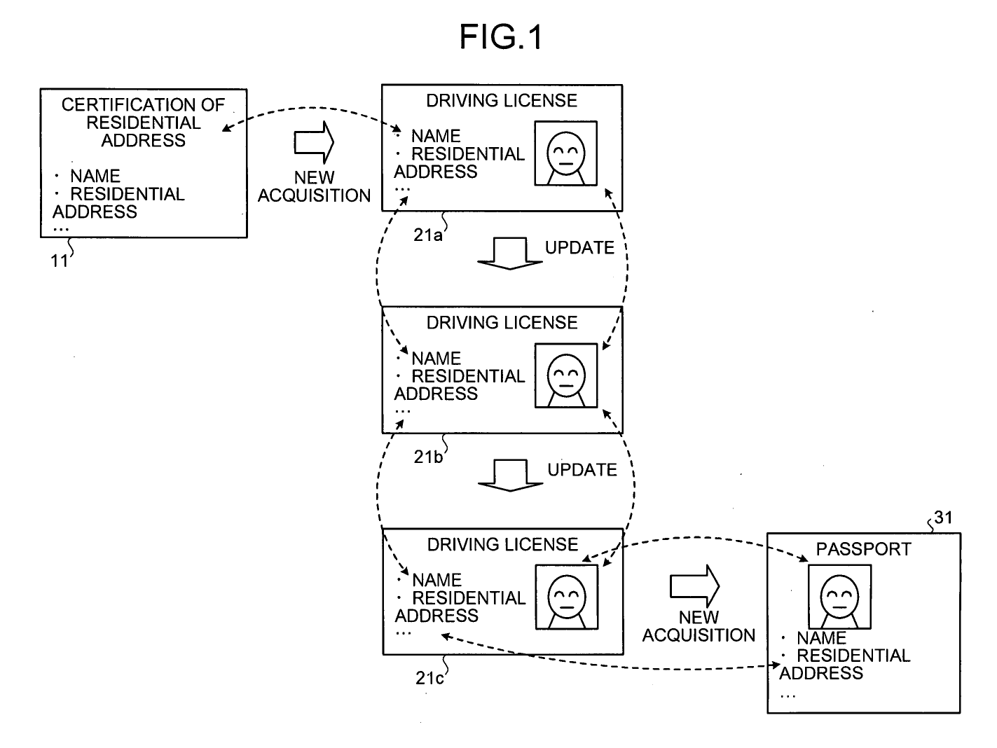

FIG. 1 is a schematic for explaining a chain of processes for verifying identity of a person when the person acquires a new passport 31. The person first acquires a certification of residential address 11, then acquires driving licenses 21a to 21c by using the certification of residential address 11, and finally acquires the new passport 31 by using the driving licenses 21a to 21c. The identity of the person is verified at each step in the above process based on identity information such as name, residential address, date of birth, and a photo of the person in the certificates.

The certification of residential address 11 contains information such as name, residential address, and date of birth of a person. In some countries, such as Japan, the certification of residential address 11 can be acquired from national or local government authorities. In some other countries, similar certificate may be obtained from private organizations.

The driving licenses 21a to 21c contain information such as name, residential address, and date of birth of a person. In some countries, such as Japan, a driving license contains a photo of the person. The use of a driving license is exemplary, in other words, any certificate that includes the information as in the driving licenses 21a to 21c can be used to person verification of identity of a person.

The certification of residential address 11 can be easily acquired by others than a relevant person due to institutional characteristics, so that it is highly possible that the certification of residential address 11 is used for spoofing. On the other hand, because the driving license 21a is acquired by using the certification of residential address 11 after verifying identity of the person, possibility of a spoofing fraud in use of the driving license 21a has to be lower.

Moreover, for the driving license 21b, which is updated from the earlier driving license 21a after verifying identity of the person, possibility of a spoofing fraud in use of the driving license 21b has to be further lower. Similarly, possibility of a spoofing fraud by using the driving license 21c is believed to be lower than that by using the driving license 21b. Moreover, possibility of a spoofing fraud by using the passport 31 is still lower than that by using the driving license 21c.

Thus, credibility of a certificate is believed to be in proportion with the number of times a certificate is updated.

Credibility Ccᵢ at the moment of use of a certificate in an i-th generation can be calculated as follows:

Ccᵢ=F(Tᵢ)+G(Cpᵢ) (1)

Where Tᵢ is a use duration of the certificate in the i-th generation; F is a function of Tᵢ to convert Tᵢ to credibility; Cpᵢ is credibility of an issuing process of the certificate in the i-th generation; and G is an increasing function of Cpᵢ.

When the certificate in the i-th generation is acquired by updating, the credibility of the issuing process includes credibility of a same certificate in the previous generation at the moment of update. When the certificate in the i-th generation is acquired based on other certificate(s), the credibility of the issuing process includes credibility of referred other certificate(s) at the moment of acquisition. Credibility of an issuing process of a certificate in an (i+1)th generation can be calculated as follows:

Cpᵢ₊₁=H(Ccᵢ₁,Ccᵢ₂, . . . ,Ccᵢₙ) (2)

Where n is number of certificate(s) that are referred as the basis for update or new acquisition of the certificate; i expresses that those certificate(s) are referred as the basis for the new certificate in the (i+1)th generation, but not necessarily to be numerical value that defines a generation itself of each referred certificate, more precisely generations of referred other certificates can vary; and H is an increasing function to add up credibility of certificate(s) referred as the basis. The equation is configured to take into account parameters where a plurality of certificates is required when acquiring a new certificate. When a new certificate is acquired based on no other certificate, credibility of an issuing process Cp is zero.

When carrying out identity verification using certificates, based on the certificates, a certificate in a new generation is issued and supposed as it is used just after the issuance, and then credibility can be computed using Equations 1 and 2. Precisely, credibility of each of the certificates at the moment of use is applied into Equation 2 to obtain credibility of an issuing process, and then the credibility of the issuing process is applied into Equation 1 as the use duration is zero, whereby credibility can be obtained when carrying out identity verification using certificates.

However, considering an actual operation in reality, it is not always favorable to compute credibility by simply with Equations 1 and 2. An example is discussed when obtaining credibility, for example, of the passport 31 shown in FIG. 1 at the moment of use. Because a date of issue is stated on the passport 31, a use duration can be determined; however, credibility of an issuing process is unknown, so that credibility of the passport 31 at the moment of use cannot be obtained only with Equation 1.

Moreover, even though credibility of the driving license 21c at the moment of acquisition of the passport 31 is applied into Equation 2 to intend to obtain credibility of an issuing process, credibility of the driving license 21c is also unknown. Thus tracing back generations of certificates, it is concluded that credibility cannot be obtained until tracing back to the certification of residential address 11 in a first generation of which credibility of an issuing process can be evaluated as zero.

Precisely, to obtain credibility of the passport 31 at the moment of use simply from Equations 1 and 2, it is required to compute credibility recursively by tracing back to the certification of residential address 11 that is an origin of generations. However, in this method, a computational effort for obtaining credibility increases, as number of generations increases, or number of certificates to be based on increases when updating a generation. Moreover, if even a part of history of generation update is unknown, credibility cannot be obtained.

Therefore, information necessary for obtaining credibility of a certificate at the moment of use is linked to the certificate to be recorded. Information necessary for obtaining credibility of a certificate at the moment of use is specifically a date of issue and credibility at the moment of issuance of the certificate. A date of issue is needed to obtain a use duration of the certificate.

A situation is discussed where a new certificate is acquired based on other certificate(s). Credibility Ccᵢⱼ of a j-th certificate necessary for acquiring a new certificate can be calculated from Equation 1 as follows:

Ccᵢⱼ=F(Tᵢⱼ)+G(Cpᵢⱼ) (3)

Now, suppose credibility of the j-th certificate at the moment of issuance is Cc0ᵢⱼ, which is expressed that Cc0ᵢⱼ=F(0)+G(Cpᵢⱼ), where Tᵢⱼ=0. Equation 3 can be transformed as follows:

Ccᵢⱼ=F(Tᵢⱼ)+Cc₀ᵢⱼ−F(0) (4)

Consequently, a date of issue necessary for obtaining Tᵢⱼ and credibility of the j-th certificate at the moment of issuance Cc0ᵢⱼ should be linked to the j-the certificate and then recorded, whereby Ccᵢⱼ can be computed. Furthermore, using Equations 1 and 2, credibility at the moment of issuance of the new certificate to be acquired can be computed.

To record a date of issue and credibility at the moment of issuance of a certificate in association with the certificate, for example, the date of issue and the credibility at the moment of issuance of the certificate cam be recorded in association with an identification number (ID number) of the certificate. Such information can be stored in an information processing device such as a computer server. Alternatively, the date of issue and the credibility at the moment of issuance of the certificate can be recorded onto the certificate physically or electronically.

When employing the former method, no additional arrangement is required to certificates, influence onto users and current operations can be minimized. When employing the latter method, there is no accidental exclusion on list, and this can ensure to acquire the date of issue and the credibility at the moment of issuance of the certificate. Moreover, there is no need to construct a massive database, so that introductory costs can be restrained.

A specific example of Equation 1 is:

Ccᵢ=D·F(Tᵢ)+Cpᵢ (5)

A specific example of Equation 2 is:

$$C {p}_{i + 1} = {\sum }_{j} C {c}_{ij} \qquad ( 6 )$$

The coefficient D is determined base on easiness of counterfeiting. The coefficient D is assumed to reflect a risk of counterfeiting on credibility, when it is able to estimate a risk of counterfeiting a certificate in physical features. Equations 5 and 6 can be simplified as follows by substituting D=1, F(Tᵢ+1)=Tᵢ+1 in Equations 5 and 6:

$$\begin{matrix}C {c}_{i} = {T}_{i} + C {p}_{i} & ( 7 ) \\ C {p}_{i + 1} = {\sum }_{j} C {c}_{ij} & ( 8 )\end{matrix}$$

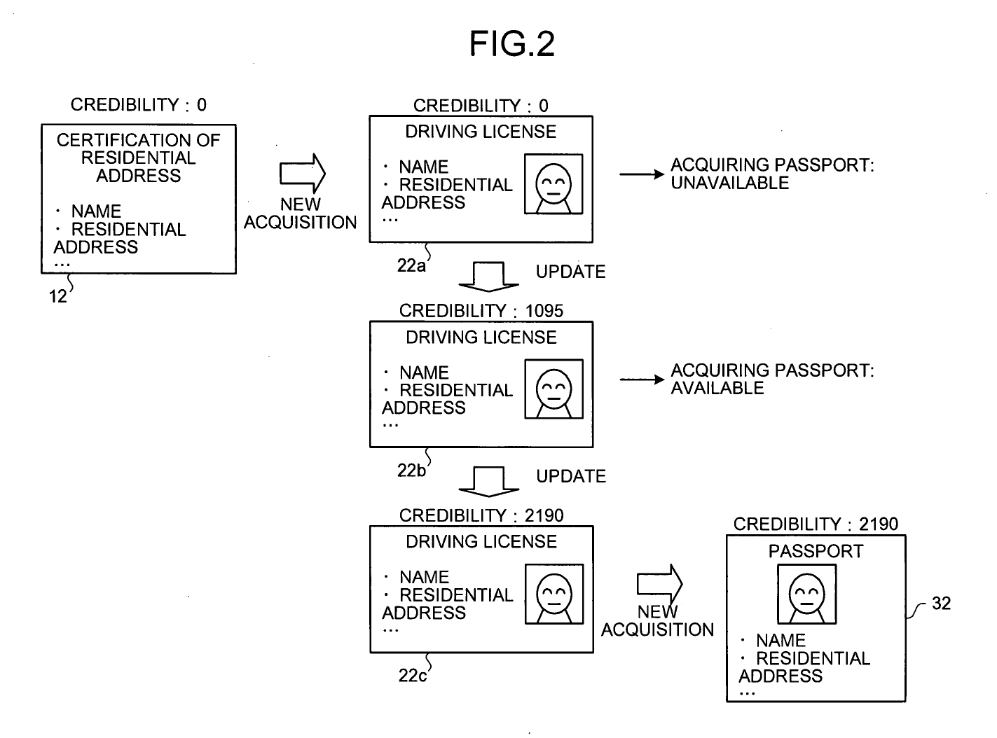

FIG. 2 is a schematic for explaining issuance of a passport when applying computed credibility using the credibility computing method according to the embodiment of the present invention. It is assumed that credibility of 1000 or more is required to acquire a passport.

Because a certification of residential address 12 can be acquired easily by other person than a person registered on the certification of residential address, credibility of the certification of residential address 12 is zero. When acquiring a driving license 22a based on the certification of residential address 12, credibility of the driving license 22a at its issuance is also zero. Because credibility does not reach 1000 at this stage, a passport 32 cannot be acquired based on the driving license 22a.

On the other hand, the driving license 22a has a photo on it, whereby spoofing for a long time is difficult. Therefore, suppose credibility of a driving license increases by 1 per day, and the credibility is taken over to an updated driving license, so that credibility of a driving license 22b, which is updated after three years, is 1095 at the moment of issuance. Now, the credibility exceeds 1000, so that the passport 32 can be acquired based on the driving license 22b.

Subsequently, a driving license 22c, which is updated further after three years, has 2190 of credibility at the moment of issuance. The credibility also exceeds 1000 at this moment, so that the passport 32 can be acquired based on the driving license 22c. In the example in FIG. 2, as soon as the driving license 22c is acquired, the passport 32 is acquired based on the driving license 22c, accordingly the credibility of the passport 32 at the moment of issuance is 2190.

When a person who intends to attain identity verification cannot provide any identification with sufficient credibility, a history of identity verification in the past can be used instead of identification. Specifically, credibility of a history of identity verification in the past that is currently still effective is to be treated equally to credibility of a certificate with a use duration of zero, which is issued at the current moment. To make this available, the history data should be provided with available information (a portrait photograph, electronic signature, biometrics information, and/or the like) for later identity verification.

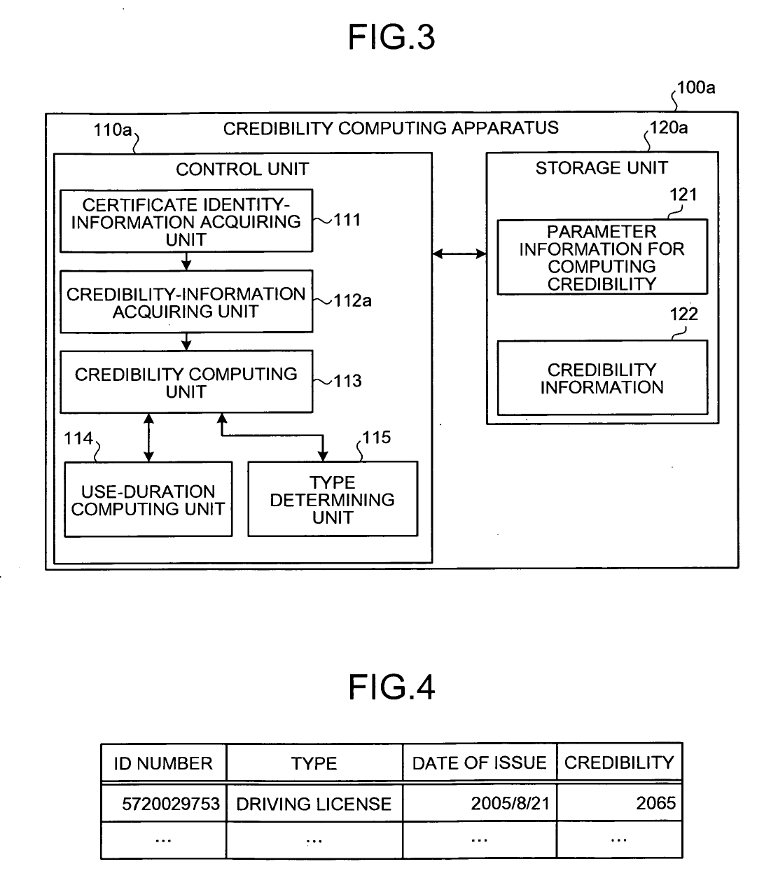

Next, a credibility computing apparatus according to the embodiment that computes credibility of a certificate is explained. FIG. 3 is a functional block diagram of a credibility computing apparatus 100a according to the embodiment. The credibility computing apparatus 100a includes a control unit 110a and a storage unit 120a.

The control unit 110a controls the credibility computing apparatus 100a, and includes a certificate identity-information acquiring unit 111, a credibility-information acquiring unit 112a, a credibility computing unit 113, a use-duration calculating unit 114, and a type determining unit 115.

The certificate identity-information acquiring unit 111 acquires an ID number of a certificate. Specifically, the certificate identity-information acquiring unit 111 acquires an ID number read by a reading unit that employs an electronic method or an optical method, or an ID number input with keyboard by an operator.

The credibility-information acquiring unit 112a acquires certificate's information corresponding to the ID number acquired by the certificate identity-information acquiring unit 111 from credibility information 122 in the storage unit 120a. An example of the credibility information 122 is shown in FIG. 4.

The credibility information 122 includes items, such as ID number, type, date of issue, and credibility, and data is registered per certificate. The ID number is an item that stores an ID number of a certificate, the type is an item that stores a type of certificate. The date of issue is an item that stores a date of issue of a certificate, the credibility is an item that stores credibility of a certificate at the moment of issuance.

In data on the first row of the example in FIG. 4, the ID number is 5720029753, the type is driving license, the date of issue is 2005/8/21, and the credibility is 2065. In other words, a driving license with a driving license number of 5720029753 has a date of issue of 2005/8/21, and credibility of 2065 at the moment of issuance.

Returning back to FIG. 3, the credibility computing unit 113 computes current credibility of a certificate corresponding to an ID number acquired by the certificate identity-information acquiring unit 111, based on information acquired by the credibility-information acquiring unit 112a. The credibility computing unit 113 computes the credibility by using Equation 4. The credibility computing unit 113 can also compute credibility at a certain moment, as well as current credibility.

The use-duration calculating unit 114 obtains a use duration of a certificate by computing an interval between a date specified by the credibility computing unit 113 and a date of issue acquired by the credibility-information acquiring unit 112a, to deliver a computed result to the credibility computing unit 113. A date of issue of a certificate can be referred to a date recorded on the certificate instead of a date recorded in the credibility information 122.

The type determining unit 115 acquires parameters for computing credibility corresponding to a type of certificate acquired by the credibility-information acquiring unit 112a from parameter information for computing credibility 121 in the storage unit 120a, to deliver a computed result to the credibility computing unit 113.

The storage unit 120a stores therein several kinds of information, including the parameter information for computing credibility 121 and the credibility information 122. The parameter information for computing credibility 121 includes parameters that are necessary for the credibility computing unit 113 to compute credibility of a certificate, for example, parameters required for computing the function F or G in Equation 1, for each type of certificate.

The credibility information 122 includes a date of issue of a certificate, its credibility at the moment of issuance, and the like. In the credibility information 122, all information of a certificate that can possibly be used is registered.

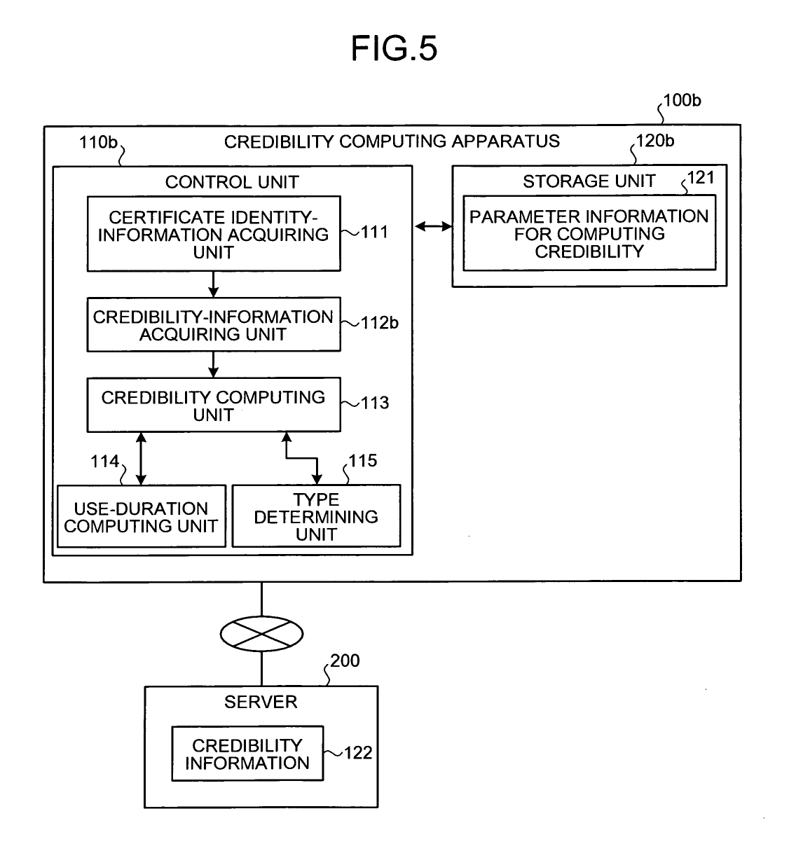

When it is difficult to register all information of a certificate that can possibly be used into the credibility computing apparatus 100a, the information can be stored in other information processing device(s), and that information can be fetched when required. FIG. 5 is a functional block diagram of a credibility computing apparatus 100b according to another embodiment of the present invention. The differences between the credibility computing apparatus 100b and the credibility computing apparatus 100a are explained below.

The credibility computing apparatus 100b is connected to a server 200 via a network. The credibility computing apparatus 100b includes a control unit 110b and a storage unit 120b. The storage unit 120b, by contrast to the storage unit 120a, does not store therein the credibility information 122. The credibility information 122 is stored in the server 200.

The control unit 10b includes a credibility-information acquiring unit 112b. The credibility-information acquiring unit 112b acquires information of a certificate corresponding to an ID number acquired by the certificate identity-information acquiring unit 111, from the credibility information 122 stored in the server 200.

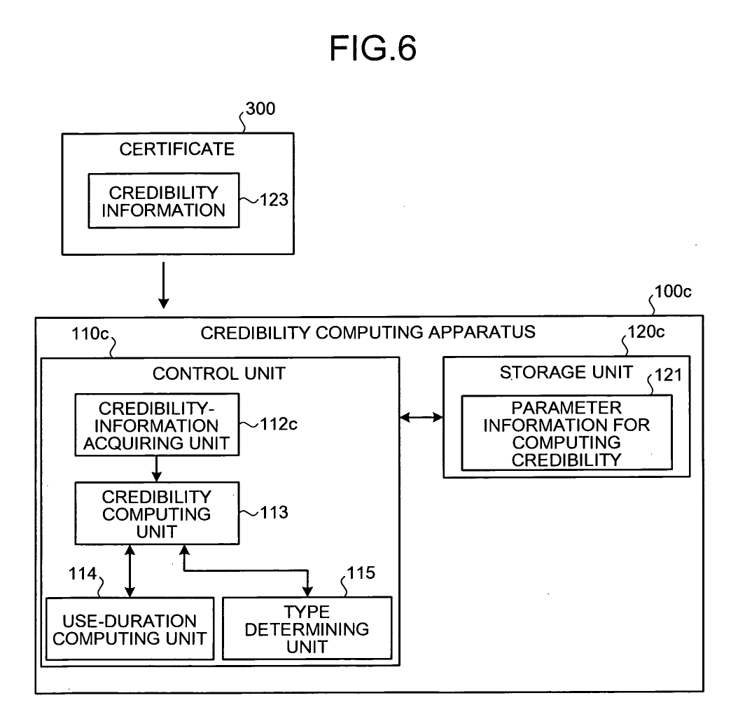

Alternatively, it is possible to have a configuration in which a date of issue and credibility at the moment of issuance of a certificate are acquired from the certificate itself. FIG. 6 is a functional block diagram of a credibility computing apparatus 100c according to still another embodiment of the present invention. The differences between the credibility computing apparatus 100c and the credibility computing apparatus 100a are explained below.

A date of issue and credibility at the moment of issuance of a certificate 300 are recorded on the certificate 300 itself as credibility information 123. Unlike the credibility information 122, the credibility information 123 includes neither date of issue nor credibility of any other certificate. Consequently, the credibility computing apparatus 100c does not request ID number of a certificate for acquiring a date of issue of the certificate and the like, thereby omitting a processing unit equivalent to the certificate identity-information acquiring unit 111.

The credibility computing apparatus 100c includes a control unit 110c and a storage unit 120c. The control unit 110c includes a credibility-information acquiring unit 112c that acquires information read from the certificate 300 with a reading device (not shown), and a date of issue and credibility at the moment of issuance of the certificate 300 from information input with a keyboard (not shown) by an operator referring to the certificate 300.

The configurations of the credibility computing apparatus 100a to 100c are examples, and each part can be separated or integrated. Furthermore, any of the configurations of the credibility computing apparatus 100a to 100c can be used in appropriate combination with any of the others. Any of the credibility computing apparatus 100a to 100c can be integrated into another device such as a certificate issuing device.

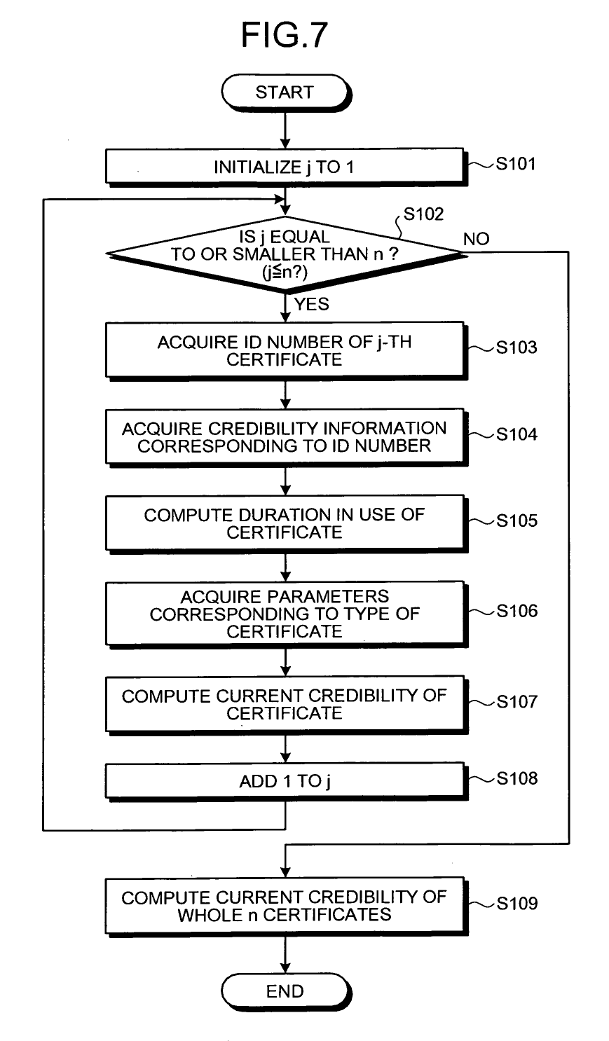

Next, a processing procedure performed by the credibility computing apparatus 100a for computing credibility is explained as an example. FIG. 7 is a flowchart of a processing procedure performed by the credibility computing apparatus 100a. This is an example of a process of obtaining current credibility of n certificates, where n is a positive integer.

To begin with, j is initialized to 1 (step S101). If j is lager than n (step S102, No), already obtained current credibility of each certificate is substituted into Equation 2, then current credibility of the whole n certificates is computed (step S109) to terminate the process.

If j is not larger than n (step S102, Yes), the certificate identity-information acquiring unit 111 acquires an ID number of a j-th certificate (step S103), and the credibility-information acquiring unit 112a acquires information, such as a date of issue and credibility at the moment of issuance, of a certificate corresponding to the ID number from the credibility information 122 (step S104).

The use-duration calculating unit 114 then computes a use duration, which is a period between a date of issue of a certificate and the current moment (step S105), the type determining unit 115 acquires parameters appropriate to a type of certificate from the parameter information for computing credibility 121 (step S106), the credibility computing unit 113 substitutes resultant information into Equation 4 or the like to compute current credibility of a j-th certificate (step S107).

Once the current credibility of the j-th certificate is computed, 1 is added to j (step S108), the system control is returned to step S102 to attempt to compute current credibility of the next certificate of the n certificates.

Next, some of applications of the credibility computing method and the credibility computing apparatus according to the embodiment are explained. In these applications, the credibility computing apparatus according to the embodiment can be independent as a single device, and also can be integrated into a device for achieving processing purpose.

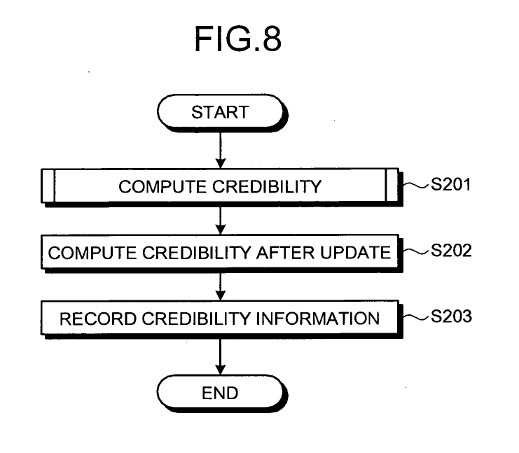

FIG. 8 is a flowchart of a certificate updating process performed by the credibility computing apparatus 100a.

When updating a certificate, the credibility computing process explained in connection with FIG. 7 is executed to obtain current credibility of the certificate before update (step S201). Credibility of the certificate at the moment of issuance after update is then computed using Equations 1, 2, and the like (step S202), and a current date and computed credibility are recorded as credibility information (step S203) to issue a new certificate.

The credibility information is recorded in the storage unit 120a in case of the credibility computing apparatus 100a, in the server 200 in case of the credibility computing apparatus 100b, and on the certificate 300 in case of the credibility computing apparatus 100c.

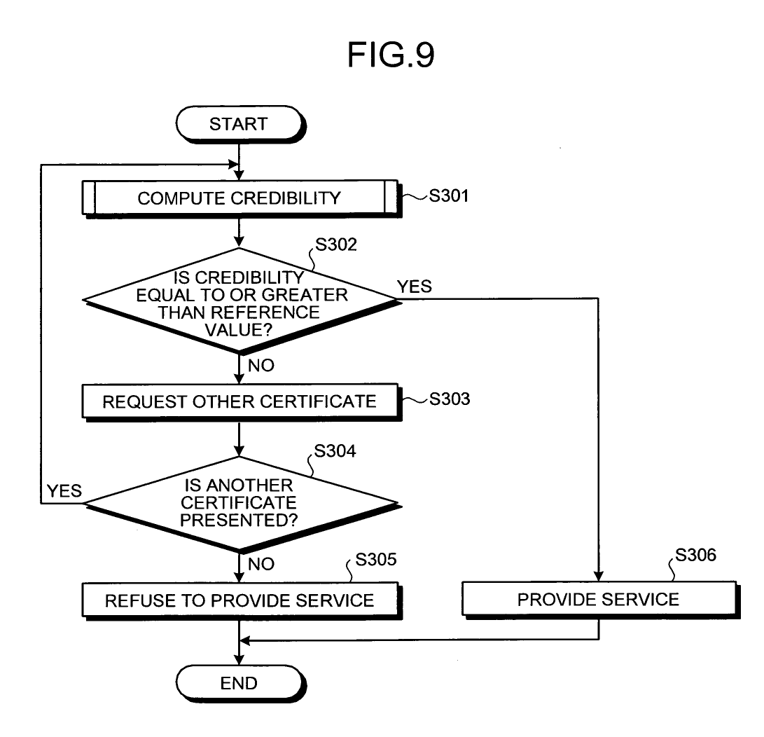

FIG. 9 is a flowchart of a process for determining availability of a service performed by the credibility computing apparatus 100a. This is an example of determining whether a service is to be provided according to a level of credibility of a certificate.

To begin with, the credibility computing process explained in connection FIG. 7 is executed to obtain current credibility of a presented certificate (step S301). If the computed credibility is equal to or greater than a reference value (step S302, Yes), a service is provided (step S306).

Otherwise (step S302, No), a request is made to present another certificate (step S303). If another certificate is presented (step S304, Yes), the system control is returned to step S301, and the processing is re-executed from computing credibility by taking an additional certificate also into account. Otherwise (step S304, No), provision of the service is refused (step S305).

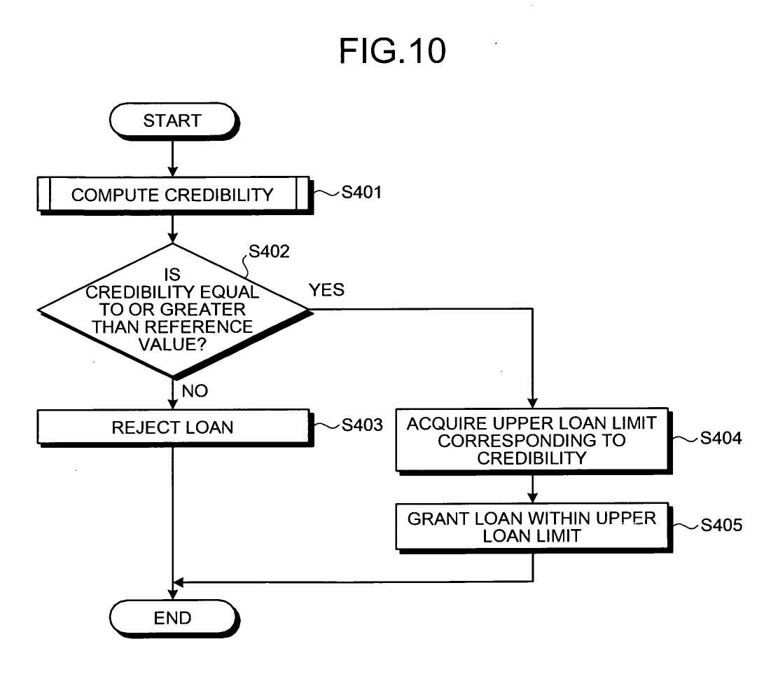

FIG. 10 is a flowchart of a process for determining a loan amount performed by the credibility computing apparatus 100a. This is an example of determining a level of a service to be provided according to a level of credibility of a certificate.

To begin with, the credibility computing process explained in connection with FIG. 7 is executed to obtain current credibility of a presented certificate (step S401). If the computed credibility is less than a reference value, (step S402, No), loan is rejected (step S403).

Otherwise (step S402, Yes), an upper loan limit appropriate to the credibility is acquired (step S404), a loan of an amount equal to or less than the upper loan limit is granted (step S405).

Functions of the credibility computing apparatus 100a to 100c can be performed by executing a computer program (hereinafter, “credibility computing program”) on a computer. An example of a computer that executes such a computer program is explained below according to an example when performing functions of the credibility computing apparatus 100a.

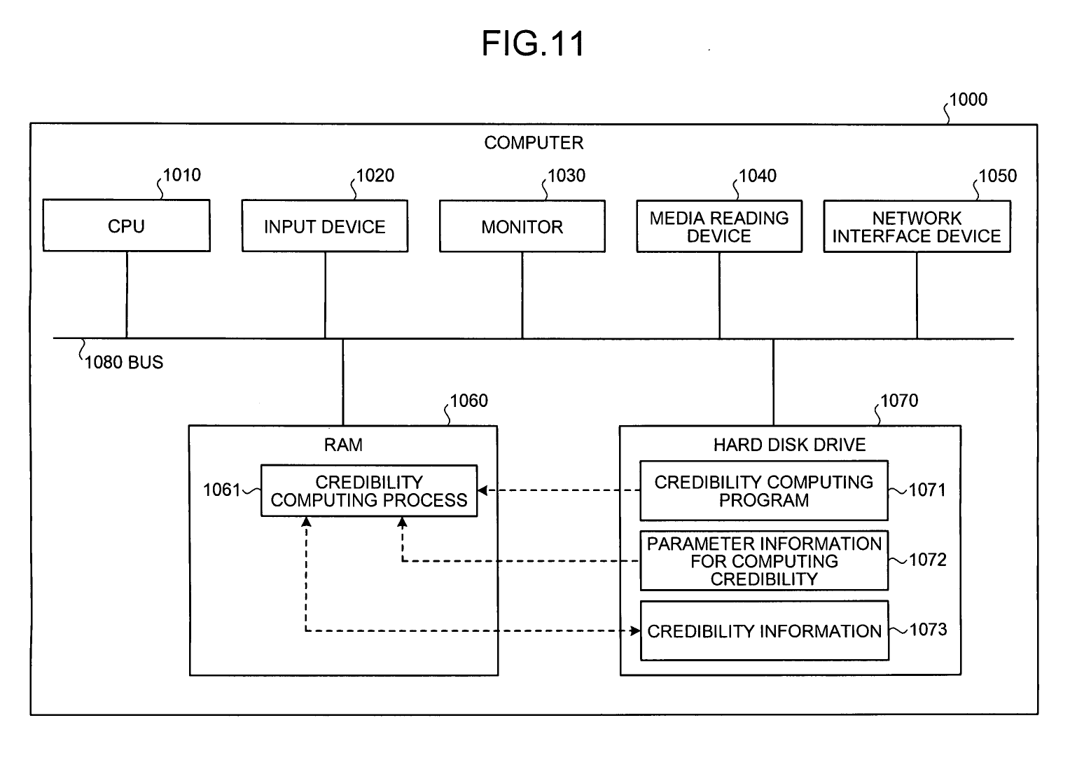

FIG. 11 is a functional block diagram of a computer 1000 that executes a credibility computing program 1071. The computer 1000 is configured by connecting a central processing unit (CPU) 1010 that executes various computations, an input device 1020 that receives data input from a user, a monitor 1030 that displays various information, a media reading device 1040 that reads out a computer program and the like from a recording media, a network interface device 1050 that exchanges data between computers via a network, a random access memory (RAM) 1060 that temporarily stores various information, and a hard disk device 1070 with a bus 1080.

The hard disk device 1070 stores therein the credibility computing program 1071 that functions similarly to the control unit 110a shown in FIG. 3, parameter information for computing credibility 1072 corresponding to the parameter information for computing credibility 121 shown in FIG. 3, and credibility information 1073 corresponding to the credibility information 122 shown in FIG. 3.

The CPU 1010 reads out the credibility computing program 1071 from the hard disk drive 1070 to develop onto the RAM 1060, whereby the credibility computing program 1071 functions as a credibility computing process 1061. In the credibility computing process 1061, information read from the parameter information for computing credibility 1072 and the credibility information 1073 is developed in a region appropriately allocated on the RAM 1060 itself to execute various data processing based on developed data and the like.

To sum up, according to the embodiment, credibility of a certificate is computed based on a use duration and credibility at the moment of issuance of the certificate, as a result, credibility indicating that a certificate is not acquired by spoofing” can be computed.

According to an embodiment of the present invention, credibility of a certificate is computed based on a use duration of the certificate. Therefore, according to an observation that a fraudulently acquired certificate tends to be destroyed as soon as a purpose is accomplished, credibility of the certificate can be evaluated appropriately.

Moreover, attribute information of a certificate necessary for computing credibility is acquired from the certificate itself. This can ensure to acquire attribute information of the certificate necessary for computing credibility.

Furthermore, attribute information of a certificate necessary for computing credibility is acquired not from the certificate itself, but from an information device. Therefore, existing certificates can be used as they are used in current operation.

Moreover, current credibility of a certificate is computed based on credibility of the certificate at the moment of issuance. Therefore, taking a case into account where at the moment of issuance identity verification is performed based on other certificate(s) or the like(s), credibility of the certificate can be evaluated appropriately.

Furthermore, credibility of a certificate is computed based on a use duration of the certificate. Therefore, according to an observation that a fraudulently acquired certificate tends to be destroyed as soon as a purpose is accomplished, credibility of the certificate can be evaluated, and then availability or a range of provision of a service can be appropriately determined based on an evaluated result.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to compute credibility of a certificate that indicates the possibility that the certificate is duly acquired by a person to be certified with the certificate, wherein the computer program causes the computer to execute:
acquiring attribute information that includes a date of issue of the certificate;
calculating a use duration of the certificate, wherein the use duration is a duration from the date of issue to a current date; and
computing credibility of the certificate based on calculated use duration.

2. The computer-readable recording medium according to claim 1, wherein the acquiring includes acquiring the attribute information from the certificate.

3. The computer-readable recording medium according to claim 1, wherein the acquiring includes acquiring the attribute information from a storage unit connected via a network to an information processing device in which the computer program is executed.

4. The computer-readable recording medium according to claim 1, wherein the attribute information includes previous credibility that is credibility of the certificate when the certificate was issued, and
the computing includes computing current credibility of the certificate based on the calculated use duration and the previous credibility.

5. The computer-readable recording medium according to claim 1, wherein
the acquiring includes acquiring attribute information of a plurality of certificates,
the calculating includes calculating a use duration of each of the certificates, and
the computing includes computing credibility of each of the certificates based on calculated credibility of a corresponding certificate, and then computing credibility of the certificates as a group from the credibility of each of the certificates.

6. The computer-readable recording medium according to claim 5, wherein the computing includes computing credibility of the group of the certificates based on credibility having computed in the past as credibility of certificate with a use duration of zero.

7. The computer-readable recording medium according to claim 1, wherein the computer program further causes the computer to execute:
determining a type of the certificate; and
acquiring a parameter for computing credibility of the certificate corresponding to the type, and
the computing includes computing credibility of the certificate by using the parameter.

8. The computer-readable recording medium according to claim 7, wherein the parameter includes a coefficient that indicates a degree of easiness of counterfeiting of the certificate, and the computer program further causes the computer to execute:
correcting the computed credibility of the certificate by using the coefficient.

9. A credibility computing apparatus that computes credibility of a certificate that indicates the possibility that the certificate is duly acquired by a person to be certified with the certificate, the credibility computing apparatus comprising:
an information acquiring unit that acquires attribute information that includes a date of issue of the certificate;
a use-duration calculating unit that calculates a use duration, wherein the use duration is a duration from the date of issue to a current date; and
a credibility computing unit that computes credibility of the certificate based on calculated use duration.

10. The credibility computing apparatus according to claim 9, wherein the information acquiring unit acquires the attribute information from the certificate.

11. The credibility computing apparatus according to claim 9, wherein the information acquiring unit acquires the attribute information from a storage unit connected via a network to an information processing device in which the computer program is executed.

12. The credibility computing apparatus according to claim 9, wherein the attribute information includes previous credibility that is credibility of the certificate when the certificate was issued, and
the credibility computing unit computes current credibility of the certificate based on the calculated use duration and the previous credibility.

13. A method of computing credibility of a certificate that indicates the possibility that the certificate is duly acquired by a person to be certified with the certificate, the method comprising:
acquiring attribute information that includes a date of issue of the certificate;
calculating a use duration of the certificate, wherein the use duration is a duration from the date of issue to a current date; and
computing credibility of the certificate based on calculated use duration.

14. The method according to claim 13, wherein the acquiring includes acquiring the attribute information from the certificate.

15. The method according to claim 13, wherein the acquiring includes acquiring the attribute information from a storage unit connected via a network to an information processing device on which the method is executed.

16. The method according to claim 13, wherein the attribute information includes previous credibility that is credibility of the certificate when the certificate was issued, and
the computing includes computing current credibility of the certificate based on the calculated use duration and the previous credibility.

17. A computer-readable recording medium that stores therein a computer program that causes a computer to determine whether to provide a service to a person based on credibility of a certificate presented by the person, wherein the computer program causes the computer to execute:
computing credibility of the certificate based on a use duration of the certificate, wherein the use duration is a duration from a date of issue of the certificate to a current date; and
determining whether to provide any one of the service and contents of the service based on comparison of computed credibility of the certificate and a threshold.

18. The computer-readable recording medium according to claim 17, wherein the computer program further causes the computer to execute requesting the person to present another certificate when the computed credibility of the certificate is smaller than the threshold.

19. The computer-readable recording medium according to claim 17, wherein the contents of the service includes an upper limit of loan, and
the computer program further causing the computer to execute the upper limit of loan based on computed credibility and information regarding a correspondence between upper limits of loan and credibility.

20. An apparatus for determining whether to provide a service to a person based on credibility of a certificate presented by the person, the apparatus comprising:
an credibility computing unit that computes credibility of the certificate based on a use duration of the certificate, wherein the use duration is a duration from a date of issue of the certificate to a current date; and
a determining unit that determines whether to provide any one of the service and contents of the service based on comparison of computed credibility of the certificate and a threshold.

21. A method of determining whether to provide a service to a person based on credibility of a certificate presented by the person, the method comprising:
computing credibility of the certificate based on a use duration of the certificate, wherein the use duration is a duration from a date of issue of the certificate to a current date; and
determining whether to provide any one of the service and contents of the service based on comparison of computed credibility of the certificate and a threshold.
